(19) United States
(12) Patent Application Publication
(10) Pub. No.: US 2006/0150601 A1
(43) Pub. Date: Jul. 13, 2006

(54) Precision aquatic vegetation harvesting system

(76) Inventor: Joshua E. Britton, Galesville, WI (US)

Correspondence Address: QUARLES & BRADY LLP, 411 E. WISCONSIN AVENUE, SUITE 2040, MILWAUKEE, WI, 53202-4497, US

(21) Appl. No.: 11/315,979

(22) Filed: Dec. 22, 2005

Related U.S. Application Data
(60) Provisional application No. 60/638,571, filed on Dec. 22, 2004.

(51) Int. Cl. A01D 44/00

(52) U.S. Cl. 56/8

(57) ABSTRACT

An aquatic vegetation harvesting system for clearing aquatic vegetation from bodies of water is disclosed. The system comprises a harvesting device, a receiver on the vessel for receiving position data from a global positioning system satellite, a storage device for storing digital map data representing a predetermined vegetation harvesting plan for the body of water, and a processor for receiving position data and digital map data wherein the processor continuously outputs harvesting signals derived from comparing position data and digital map data to the dispensing system to the harvesting device or to a user display such that the harvesting device may be activated to harvest the vegetation. The system also provides a method in which position data representing a location of the vessel on the body of water are stored in a storage device along with an on-off status indicator for the harvesting device associated with each location such that the harvesting operation performed at each location can be reviewed after the vessel is directed over the body of water.

### CROSS-REFERENCES TO RELATED APPLICATIONS

The application claims benefit from U.S. Provisional Patent Application No. 60/638,571 filed Dec. 22, 2004.

### STATEMENT REGARDING FEDERALLY SPONSORED RESEARCH

Not Applicable.

### BACKGROUND OF THE INVENTION

1. Field of the Invention

This invention relates to an aquatic vegetation harvesting system used to harvest aquatic vegetation in or on a body of water.

2. Description of the Related Art

Thick aquatic vegetation in bodies of water impedes navigation, interferes with recreational use, and produces objectionable odors when the vegetation decays. Therefore, various methods and equipment for harvesting aquatic vegetation have been proposed to solve these problems. See, for example, U.S. Pat. Nos. 5,551,900, 5,404,696, 5,372,001, 5,201,168, 4,196,566 and 3,238,708.

While these methods and equipment may be acceptable for some bodies of water, they have disadvantages. For example, these methods and equipment may have limited control over the transfer of power from an engine to the cutting blades such that energy is wasted moving the cutting blades in areas where non-target species exist or where vegetation does not exist.

Therefore, there is a need for an improved system for harvesting aquatic vegetation in or on bodies of water such that energy usage is minimized in powering the cutting blades.

### SUMMARY OF THE INVENTION

The foregoing needs are met by an aquatic vegetation harvesting system according to the invention. The aquatic vegetation harvesting system is suitable for harvesting vegetation in or on a body of water from a floating vessel. The system includes a harvesting device associated with the floating vessel. The harvesting device is suitable for harvesting vegetation in or on the body of water. The system also includes a receiver on the vessel for receiving position data from a global positioning system satellite when the vessel is directed over the body of water. A storage device for storing digital map data representing a predetermined vegetation harvesting plan for the body of water is provided in the system, and a processor in communication with the receiver and the storage device for receiving position data and digital map data is also provided. The processor continuously outputs harvesting signals derived from comparing position data and digital map data when the vessel is directed over the body of water. The harvesting signals are indicative of a harvesting plan at a position on the body of water. The processor may be in communication with the harvesting device for providing harvesting signals to the harvesting device. The harvesting signals activate the harvesting device such that vegetation is harvested in or on the body of water in accordance with the predetermined vegetation harvesting plan for the body of water. Alternatively, the processor may be in communication with a user device for providing harvesting signals to the user, such as a monitor display or a device providing an audible signal. Upon viewing an indication of harvesting signals at the user display, a user may activate the harvesting device such that vegetation is harvested in or on the body of water in accordance with the predetermined vegetation harvesting plan for the body of water.

In another aspect, the invention provides a method for harvesting vegetation on or in a body of water from a floating vessel. In the method, a harvesting device is associated with the floating vessel. The harvesting device is suitable for harvesting vegetation in or on the body of water. A digital map data is stored representing a predetermined vegetation harvesting plan for the body of water in a digital storage device. The floating vessel is directed over the body of water. Position data is received in a receiver from a global positioning system satellite when the vessel is directed over the body of water. A processor in communication with the receiver and the storage device continuously outputs harvesting signals derived from comparing position data and digital map data when the vessel is directed over the body of water. The harvesting signals are indicative of a harvesting plan at a position on the body of water. In one version of the method, the harvesting signals are provided to the harvesting device to automatically activate the harvesting device such that vegetation is harvested in or on the body of water in accordance with the predetermined vegetation harvesting plan for the body of water when a harvesting signal indicating that the harvesting device should be activated is received by the harvesting device. In another version of the method, the processor provides harvesting signals to a user display, and a user activates the harvesting device in dependence on the user display such that vegetation is harvested in or on the body of water in accordance with the predetermined vegetation harvesting plan for the body of water.

In yet another aspect, the invention provides a method for harvesting vegetation on or in a body of water from a floating vessel. In the method, the vessel has a harvesting device suitable for harvesting vegetation in or on the body of water. The vessel is directed over the body of water, and the harvesting device is activated at one or more regions on the body of water such that vegetation is harvested in or on the body of water in each region. Position data are received from a global positioning system satellite when the vessel is directed over the body of water. The position data representing a location of the vessel on the body of water are stored in a storage device, and an on-off status indicator for the harvesting device associated with each location is stored in the storage device such that the harvesting operation performed at each location can be reviewed after the vessel is directed over the body of water.

These and other features, aspects, and advantages of the present invention will become better understood upon consideration of the following detailed description, drawings, and appended claims.

### BRIEF DESCRIPTION OF THE DRAWINGS

FIG. 1 shows an air boat with an associated harvesting device that may be used as an aquatic vegetation harvesting system according to the invention.

FIG. 2 shows the onboard controllers according to the version of the aquatic vegetation harvesting system shown in FIG. 1.

### DETAILED DESCRIPTION OF THE INVENTION

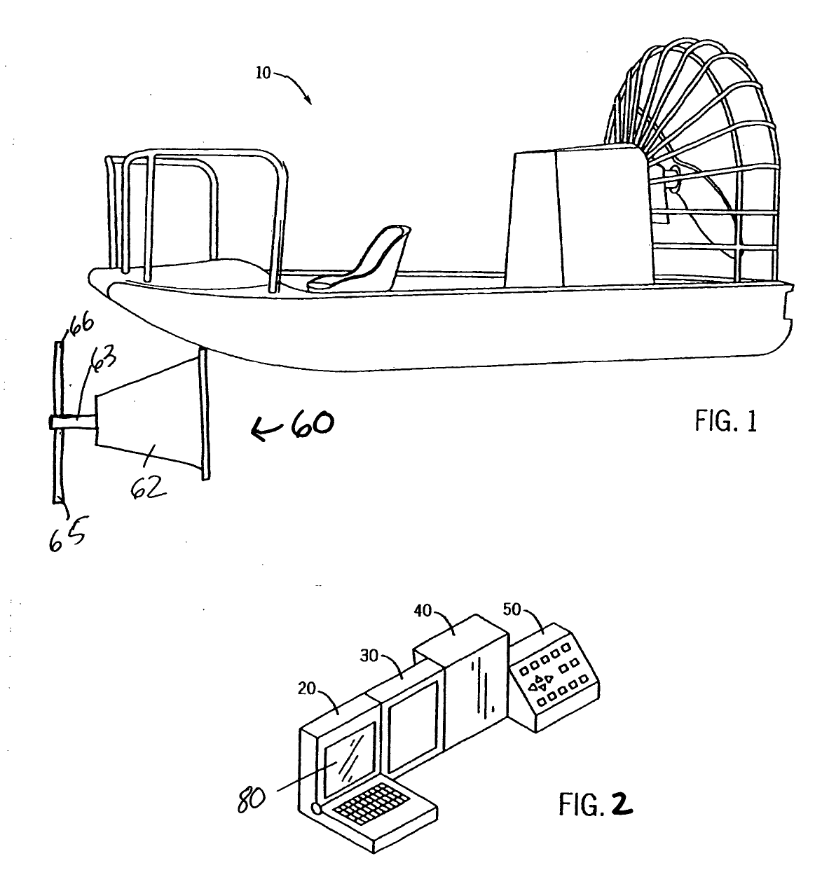

The present invention is directed to an aquatic vegetation harvesting system for harvesting vegetation in or on a body of water from a floating vessel. The system (as depicted in FIGS. 1-2) includes vessel 10, a harvesting device 60 for harvesting vegetation in or on the body of water, a receiver 30 on the vessel 10 for receiving position data from a global positioning system satellite, a storage device 40 for storing digital map data, and a processor 20 for receiving position data and digital map data wherein the processor 20 continuously outputs harvesting signals derived from comparing position data and digital map data to the harvesting device 60 or to a user display 80.

The aquatic vegetation harvesting system includes harvesting device 60 for harvesting vegetation in the body of water. Harvesting device 60 includes a conventional motor 62 for driving a shaft 63 upon which is mounted cutting blades 65 and 66 for harvesting vegetation in the body of water. This is merely one example of a harvesting device, and systems such that those shown in U.S. Pat. Nos. 5,551,900, 5,404,696, 5,372,001, 5,201,168, 4,196,566 and 3,238,708 (which are incorporated herein by reference) could also be associated with the vessel 10 for harvesting vegetation in or on the body of water. Commercially available aquatic plant harvesters, such as those sold by Aquarius Systems, North Prairie, Wis., USA, could also be associated with the vessel 10 for harvesting vegetation in the body of water. Cutting blades 65 and 66 of the harvesting device 60 can be manually activated by a user starting the motor 62, or by a user engaging a transmission to rotate the shaft 63. Cutting blades 65 and 66 of the harvesting device 60 can also be automatically activated by harvesting signals from the processor 20 that, for example, cause engagement of a transmission to rotate the shaft 63. Such electronic control of motors and transmissions is known to those skilled in the art.

The receiver 30 on the vessel 10 operates as follows. The receiver 30 uses the global positioning system (GPS) to provide exact and continually updated information concerning the position of the vessel 10 in global coordinates. Such receivers are commercially available Ag-Chem Sales Co., Inc., Jackson, Minn., USA under the brand name Starlink®, and may include differential correction methods to integrate data from a number of satellites and reference stations. The receiver 30 can receive from GPS satellites and provide the correct latitude, longitude and altitude of the vessel 10, along with the precise time and date, and the speed and track over the body of water of the vessel 10. Such data can then be transmitted to the processor 20 to be used as hereinafter described.

The aquatic vegetation harvesting system includes a storage device 40 for storing digital map data representing a predetermined vegetation harvesting plan for the body of water. A predetermined digitized map including a vegetation harvesting plan for the body of water to be treated is entered into a data base which is stored in the storage device 40. Such a predetermined digitized map including a vegetation harvesting plan can be created using SGIS 3® or HGIS® software and equipment sold by Soilteq, Minnetonka, Minn., USA. Such software and equipment provides for, among other things, the mapping of a body of water and vegetation within the body of water using global coordinates.

A review of the location of vegetation within the body of water provides the global coordinates where the cutting blades 65 and 66 must be activated for harvesting the vegetation in the body of water. For example, the predetermined digitized map including a vegetation harvesting plan for the body of water would include data signaling the use of the cutting blades 65 and 66 at the global coordinates where the vegetation is located. The predetermined digitized map including a vegetation harvesting plan for the body of water may include data on water depth at global coordinates on the body of water, or data on water quality parameters (such as pH or dissolved oxygen) at global coordinates on the body of water.

Under certain circumstances, it may also be desirable for the vessel 10 to follow a predetermined path on the body of water. In these situations, a predetermined digitized map including a path on the body of water can be created using the SGIS 3® or HGIS® software and equipment sold by Soilteq, Minnetonka, Minn., USA. Such software and equipment provides for a mapping of a body of water that allows for the creation of a path across the body of water.

The storage device 40 may be part of the processor 20 or a separate interfaced device. The vegetation harvesting plan can be extracted by the processor 20 to control the harvesting device 60 such that any vegetation at each body of water reference point is accurately and precisely harvest.

The processor 20 uses the predetermined digitized map including a vegetation harvesting plan and the aforesaid latitude, longitude, speed and track data from the receiver 30 for determining harvesting points and rates for the harvesting device on or under the surface of the body of water. The processor 20 may also use the predetermined digitized map including a path across the body of water and the aforesaid latitude, longitude, speed and track data from the receiver 30 for assisting in the navigation of the vessel 10 over the body of water. In situations where such navigation capabilities are desired, a navigation device 50 (such as a light bar commercially available from Ag-Chem Sales Co., Inc., Jackson, Minn., USA) in communication with the processor 20 for receiving the navigation signals from the processor 20 is provided on the vessel 10. The navigation device 50 indicates deviation from the predetermined path for the vessel on the body of water based on the navigation signals received from the processor 20. For example, a deviation to the left off of the predetermined path may light a rightward facing arrow on the light bar.

The processor 20 may be a microcomputer but may also be any other type of digital or analog computer or controller which can receive the required data and process it, such as a laptop computer or a PDA. One commercially available processor suitable for use with the invention is sold under the trademark Falcon® by Ag-Chem Sales Co., Inc., Jackson, Minn., USA.

The processor 20 may also use data from various sensors for determining harvesting points on or under the surface of the body of water. For example, the aquatic vegetation harvesting system may include a commercially available water depth sensor in communication with the processor for providing water depth signals to the processor 20, and/or a commercially available speed sensor in communication with the processor 20 for providing speed signals to the processor 20. The aquatic vegetation harvesting system may also include a pH sensor in communication with the processor for providing pH signals to the processor 20. The aquatic vegetation harvesting system may also include a dissolved oxygen sensor in communication with the processor 20 for providing dissolved oxygen signals to the processor 20.

An example operating sequence for the invention is as follows. Using the SGIS 3® or HGIS® software and equipment, a coordinate map is created for a body of water along with the location of three plant species in the body of water. A predetermined digitized map including a vegetation harvesting plan is then created. In a first area of coordinates, a first plant species must be harvested; in a second area of coordinates, a second species must be harvested; and in a third area of coordinates, a third plant species must be harvested.

The predetermined digitized map including a vegetation harvesting plan is entered into a storage device 40 on the vessel. The storage device 40 communicates the predetermined digitized map with a processor 20 on the vessel 10. The vessel 10 is then directed over a body of water. The receiver 30 continuously provides the correct latitude, longitude, time, date, speed and track of the vessel 10 over the body of water to the processor 20. The processor 20 continuously compares latitude, longitude, time, date, speed and track data from the receiver 30 and digital map data when the vessel 10 is directed over the body of water. Based on this data, the processor 20 transmits harvesting signals to the harvesting device 60, which are indicative of a need to activate cutting blades 65 and 66 for harvesting vegetation at a position on the body of water.

For instance, when the vessel 10 is in the first area, the processor 20 provides harvesting signals to the harvesting device 60 to activate cutting blades 65 and 66 for harvesting the first plant species. The harvesting can vary depending on the speed of the vessel and the depth of the water. Changes in speed and water depth are continuously fed to the processor 20 (by way of GPS or sensors) and the processor 20 continuously sends appropriate adjusted harvesting signals to the harvesting device 60. When the vessel is in the second area, the processor 20 provides harvesting signals to the harvesting device 60 to activate cutting blades 65 and 66 for harvesting the second plant species. When the vessel is in the third area, the processor 20 provides harvesting signals to the harvesting device 60 to activate cutting blades 65 and 66 for harvesting the third plant species.

The storage device 40 or another storage device can store position data and harvesting signals received from the processor 20 when the vessel is directed over the body of water such that the performed harvesting operations can be reviewed after the vessel 10 is directed over the body of water.

In another version of the invention, the predetermined digitized map including a vegetation harvesting plan is entered into a storage device 40 on the vessel. The storage device 40 communicates the predetermined digitized map with processor 20 on the vessel 10. The vessel 10 is then directed over a body of water. The receiver 30 continuously provides the correct latitude, longitude, time, date, speed and track of the vessel 10 over the body of water to the processor 20. The processor 20 continuously compares latitude, longitude, time, date, speed and track data from the receiver 30 and digital map data when the vessel 10 is directed over the body of water. Based on this data, the processor 20 transmits harvesting signals to the user display 80, which are indicative of a need to activate cutting blades 65 and 66 for harvesting vegetation at a position on the body of water. For example, an “activate cutting blades” message may appear on the user display 80. The user then manually activates cutting blades 65 and 66 for harvesting vegetation. The storage device 40 or another storage device can store position data and harvesting signals received from the processor 20 when the vessel is directed over the body of water such that the performed harvesting operations can be reviewed after the vessel 10 is directed over the body of water.

In yet another version of the invention, the vessel 10 is directed over a body of water. No predetermined digitized map is required. The user manually activates cutting blades 65 and 66 for harvesting vegetation at one or more regions on the body of water. The storage device 40 stores position data and harvesting on-off signals received from the processor 20 when the vessel is directed over the body of water such that the performed harvesting operations at the locations on the body of water can be reviewed after the vessel 10 is directed over the body of water.

Thus, there has been provided an aquatic vegetation harvesting system for precisely harvesting aquatic vegetation in or on a body of water.

Although the present invention has been described in considerable detail with reference to certain embodiments, one skilled in the art will appreciate that the present invention can be practiced by other than the described embodiments, which have been presented for purposes of illustration and not of limitation. Therefore, the scope of the appended claims should not be limited to the description of the embodiments contained herein.

What is claimed is:

1. An aquatic vegetation harvesting system for harvesting vegetation in or on a body of water from a floating vessel, the system comprising:
a harvesting device associated with the floating vessel, the harvesting device being suitable for harvesting vegetation in or on the body of water;
a receiver on the vessel for receiving position data from a global positioning system satellite when the vessel is directed over the body of water;
a storage device for storing digital map data representing a predetermined vegetation harvesting plan for the body of water; and
a processor in communication with the receiver and the storage device for receiving position data and digital map data, the processor continuously outputting harvesting signals derived from comparing position data and digital map data when the vessel is directed over the body of water, the harvesting signals being indicative of a harvesting plan at a position on the body of water, the processor being in communication with the harvesting device for providing harvesting signals to the harvesting device such that vegetation is harvested in or on the body of water in accordance with the predetermined vegetation harvesting plan for the body of water when a harvesting signal indicating that the harvesting device should be activated is received by the harvesting device.

2. The aquatic vegetation harvesting system of claim 1 wherein:
the digital map data representing a predetermined vegetation harvesting plan for the body of water includes data on water depth at positions on the body of water.

3. The aquatic vegetation harvesting system of claim 1 wherein:
the digital map data representing a predetermined vegetation harvesting plan for the body of water includes data on at least one species of vegetation in or on the body of water.

4. The aquatic vegetation harvesting system of claim 1 wherein:
the digital map data further represents a predetermined path for the vessel on the body of water,
the processor continuously outputs navigation signals derived from comparing position data and digital map data when the vessel is directed over the body of water, and
the aquatic vegetation harvesting system further comprises a navigation device in communication with the processor for receiving the navigation signals from the processor, the navigation device indicating deviation from the predetermined path for the vessel on the body of water based on the navigation signals received from the processor.

5. The aquatic vegetation harvesting system of claim 1 wherein:
the storage device or another storage device stores position data and harvesting signals received from the processor when the vessel is directed over the body of water such that the harvesting operation performed at each position can be reviewed after the vessel is directed over the body of water.

6. An aquatic vegetation harvesting system for harvesting vegetation in or on a body of water from a floating vessel, the system comprising:
a harvesting device associated with the floating vessel, the harvesting device being suitable for harvesting vegetation in or on the body of water;
a receiver on the vessel for receiving position data from a global positioning system satellite when the vessel is directed over the body of water;
a storage device for storing digital map data representing a predetermined vegetation harvesting plan for the body of water; and
a processor in communication with the receiver and the storage device for receiving position data and digital map data, the processor continuously outputting harvesting signals derived from comparing position data and digital map data when the vessel is directed over the body of water, the harvesting signals being indicative of a harvesting plan at a position on the body of water, the processor being in communication with a user device for providing harvesting signals to a user such that a user may activate the harvesting device such that vegetation is harvested in or on the body of water in accordance with the predetermined vegetation harvesting plan for the body of water.

7. The aquatic vegetation harvesting system of claim 6 wherein:
the user device is a display.

8. The aquatic vegetation harvesting system of claim 6 wherein:
the digital map data representing a predetermined vegetation harvesting plan for the body of water includes data on at least one species of vegetation in or on the body of water.

9. The aquatic vegetation harvesting system of claim 6 wherein:
the digital map data further represents a predetermined path for the vessel on the body of water,
the processor continuously outputs navigation signals derived from comparing position data and digital map data when the vessel is directed over the body of water, and
the aquatic vegetation harvesting system further comprises a navigation device in communication with the processor for receiving the navigation signals from the processor, the navigation device indicating deviation from the predetermined path for the vessel on the body of water based on the navigation signals received from the processor.

11. The aquatic vegetation harvesting system of claim 6 wherein:
the storage device or another storage device stores position data and harvesting signals received from the processor when the vessel is directed over the body of water such that the harvesting operation performed at each position can be reviewed after the vessel is directed over the body of water.

12. An aquatic vegetation harvesting system for harvesting vegetation in or on a body of water from a floating vessel, the system comprising:
a harvesting device associated with the floating vessel, the harvesting device being suitable for harvesting vegetation in or on the body of water;
a receiver on the vessel for receiving position data from a global positioning system satellite when the vessel is directed over the body of water; and
a storage device for storing the position data representing a location of the vessel on the body of water and for storing an on-off status indicator for the harvesting device associated with each location such that the harvesting operation performed at each location can be reviewed after the vessel is directed over the body of water.

13. A method for harvesting vegetation on or in a body of water from a floating vessel, the method comprising:
providing a harvesting device associated with the floating vessel, the harvesting device being suitable for harvesting vegetation in or on the body of water;
storing digital map data representing a predetermined vegetation harvesting plan for the body of water in a digital storage device;
directing the floating vessel over the body of water;
receiving position data in a receiver from a global positioning system satellite when the vessel is directed over the body of water;
continuously outputting, from a processor in communication with the receiver and the storage device, harvesting signals derived from comparing position data and digital map data when the vessel is directed over the body of water, the harvesting signals being indicative of a harvesting plan at a position on the body of water; and
providing from the processor harvesting signals to the harvesting device such that vegetation is harvested in or on the body of water in accordance with the predetermined vegetation harvesting plan for the body of water when a harvesting signal indicating that the harvesting device should be activated is received by the harvesting device.

14. The method of claim 13 wherein:
the digital map data further represents a predetermined path for the vessel on the body of water,
the processor continuously outputs navigation signals derived from comparing position data and digital map data when the vessel is directed over the body of water, and
the method further comprises receiving in a navigation device the navigation signals from the processor, the navigation device indicating deviation from the predetermined path for the vessel on the body of water based on the navigation signals received from the processor.

15. The method of claim 13 further comprising:
storing in the storage device or another storage device, position data and harvesting signals received from the processor when the vessel is directed over the body of water such that the harvesting operation performed at each position can be reviewed after the vessel is directed over the body of water.

16. A method for harvesting vegetation on or in a body of water from a floating vessel, the method comprising:
providing a harvesting device associated with the floating vessel, the harvesting device being suitable for harvesting vegetation in or on the body of water;
storing digital map data representing a predetermined vegetation harvesting plan for the body of water in a digital storage device;
directing the floating vessel over the body of water;
receiving position data in a receiver from a global positioning system satellite when the vessel is directed over the body of water;
continuously outputting, from a processor in communication with the receiver and the storage device, harvesting signals derived from comparing position data and digital map data when the vessel is directed over the body of water, the harvesting signals being indicative of a harvesting plan at a position on the body of water;
providing from the processor harvesting signals to a signaling device; and
activating the harvesting device in dependence on the signaling device such that vegetation is harvested in or on the body of water in accordance with the predetermined vegetation harvesting plan for the body of water.

17. The method of claim 16 wherein:
the signaling device is a user display.

18. The method of claim 16 wherein:
the digital map data further represents a predetermined path for the vessel on the body of water,
the processor continuously outputs navigation signals derived from comparing position data and digital map data when the vessel is directed over the body of water, and
the method further comprises receiving in a navigation device the navigation signals from the processor, the navigation device indicating deviation from the predetermined path for the vessel on the body of water based on the navigation signals received from the processor.

19. The method of claim 16 further comprising:
storing in the storage device or another storage device, position data and harvesting signals received from the processor when the vessel is directed over the body of water such that the harvesting operation performed at each position can be reviewed after the vessel is directed over the body of water.

20. A method for harvesting vegetation on or in a body of water from a floating vessel, the method comprising:
providing a harvesting device associated with the floating vessel, the harvesting device being suitable for harvesting vegetation in or on the body of water;
directing the floating vessel over the body of water;
activating the harvesting device at one or more regions on the body of water such that vegetation is harvested in or on the body of water in each region;
receiving position data from a global positioning system satellite when the vessel is directed over the body of water;
storing the position data representing a location of the vessel on the body of water in a storage device; and
storing in the storage device an on-off status indicator for the harvesting device associated with each location such that the harvesting operation performed at each location can be reviewed after the vessel is directed over the body of water.
